(19) United States
(12) Patent Application Publication
(10) Pub. No.: US 2026/0300849 A1
(43) Pub. Date: Oct. 1, 2026

(54) MULTI-AGENT BASED AI SYSTEM WITH FEW-SHOT PROMPTING FOR OPTIMIZATION PROBLEMS

(71) Applicant: PwC Product Sales LLC, New York, NY (US)

(72) Inventors: Arit Kumar BISHWAS, Fremont, CA (US); Arish PITCHAI, Madurai (IN); Zhijie TANG, Zhejiang (CN); Joel Jacob VARGHESE, Kochi (IN)

(73) Assignee: PwC Product Sales LLC, New York, NY (US)

(21) Appl. No.: 19/631,667

(22) Filed: Mar. 27, 2026

(30) Foreign Application Priority Data
Mar. 28, 2025 (WO) PCT/CN2025/085869

(51) Int. Cl. G06Q 10/04; G06F 16/22; G06F 16/3329

(52) U.S. Cl. CPC G06Q 10/04; G06F 16/2237; G06F 16/3329

(57) ABSTRACT

A system receives a user input comprising a natural language problem statement specifying one or more characteristics of the optimization problem; generates one or more embeddings representing the user input; queries a vector database using the one or more generated embeddings to identify one or more example optimization problems; retrieves information associated with one or more of the identified example optimization problems from a file location indicated by the vector database; generates a plurality of few-shot prompts for an LLM agent pipeline comprising a plurality of LLM agents, wherein the plurality of few-shot prompts are generated using the user input and the information associated with the one or more example optimization problems; inputs input a respective one of the plurality of generated prompts into each of the plurality of LLM agents; and generates computer executable code specifying one or more characteristics of the optimization problem using the LLM agent pipeline.

### CROSS-REFERENCE TO RELATED APPLICATIONS

This application claims priority to and the benefit of International Application No. PCT/CN2025/085869, filed Mar. 28, 2025, the entire contents of which are incorporated herein by reference.

### FIELD

This disclosure relates generally to large language model (LLM) agents and more specifically to using multiple specialized LLM agents to solve optimization problems.

### BACKGROUND

Optimization problems are fundamental challenges encountered across diverse fields, including economics, engineering, and computer science. Such problems involve identifying optimal solutions that either maximize or minimize a specific objective function. Real-world applications of optimization are extensive and impactful. They can be leveraged to significantly reduce energy consumption in smart grids, streamline and enhance supply chain efficiency, or maximize profitability in algorithmic trading operations.

Despite their practical benefits, optimization problems frequently pose significant computational difficulties. Many of these problems demand considerable computational resources and extended processing times, and some are even beyond the capabilities of traditional annealing algorithms and standard computing architectures. Moreover, despite the potential benefits of optimization modeling—e.g., translating a business problem into a mathematical optimization problem—the process demands specialized expertise. This requirement for specialized knowledge creates a barrier that prevents numerous organizations from leveraging optimization methods to enhance their operations.

### SUMMARY

Disclosed herein are systems, devices, and methods for solving optimization problems using one or more LLM agents or other generative artificial-intelligence-based agents (referred to herein, for illustrative purposes, as “LLM agents”). The one or more LLM agents may be configured to transform a natural language user input into computer executable code that can be used to solve optimization problems. Retrieval-augmented-generation (RAG) and few-shot prompting (e.g., using retrieved information associated with similar optimization problems to prompt LLM agents) may enhance the one or more LLM agents'ability to transform a natural language user input into computer executable code that can be used to automatically determine solutions to optimization problems. For instance, large language models (LLMs) have been shown to “hallucinate,” leading to inaccurate outputs and results. By leveraging RAG and few-shot prompting, the techniques disclosed herein mitigate hallucinations by providing the LLM agents with relevant examples and context to guide their creation of an output, enhancing the LLM's ability to accurately and effectively transform a natural language input received from a user into computer executable code for solving different types of optimization problems.

In some embodiments, any one or more of the characteristics of any one or more of the systems, methods, and/or computer-readable storage mediums recited herein may be combined, in whole or in part, with one another and/or with any other features or characteristics described elsewhere herein.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 illustrates an exemplary block diagram representing a computing system for solving optimization problems using a plurality of large language model (LLM) agents and a solver, according to some embodiments.

FIG. 2 illustrates an exemplary method for creating a vector database that may be used according to the systems and methods herein to solve optimization problems, according to some embodiments

FIG. 3 illustrates an exemplary method for creating a vector database using files associated with optimization problems that have been enhanced with synthetic data generated using a generative AI model (e.g., an LLM), according to some embodiments.

FIG. 4 illustrates an exemplary method 400 for solving an optimization problem using a plurality of LLM agents, according to some embodiments.

FIGS. 5-15 illustrate aspects of graphical user interfaces (GUIs) that may be implemented in accordance with the examples disclosed herein, according to some embodiments.

FIG. 16 illustrates an exemplary block diagram representing a computing system for solving optimization problems using subsets of LLM agents operating in parallel and a solver, according to some embodiments.

FIG. 17 depicts an exemplary computing device, according to some embodiments.

### DETAILED DESCRIPTION

Disclosed herein are systems, devices, and methods for solving optimization problems using one or more LLM agents. The one or more LLM agents may be configured to transform a natural language user input into computer executable code that can be used to solve optimization problems. An LLM agent, as used herein, may refer to an AI-powered software module. An LLM agent may include or have access to one or more large language models (LLMs), other machine learning model(s), including other generative AI models, memory, and/or other tools such as application programming interfaces (APIs), data visualization software, etc. In some examples, a plurality of LLM agents are used to transform a natural language user input into computer executable code. Each of the plurality of LLM agents may be prompted by the system to perform a particular task contributing to the transformation of the user input into computer executable code.

As noted above, retrieval-augmented-generation (RAG) and few-shot prompting (e.g., using information retrieved from similar example optimization problems to prompt LLM agents) may enhance the one or more LLM agents'ability to perform their respective task contributing to the transformation. Few-shot prompting involves providing an LLM agent with examples of desired outputs, enabling the LLM agents to generalize better to unseen data while refining their ability to perform a specific task (such as quantum annealing code generation) with significantly less training data than typically required for traditional supervised learning methods. RAG enables the system to retrieve the most relevant examples for an LLM agent given the specific optimization problem to be solved—for instance, the system can identify an optimization problem that is of the same type (e.g., same mathematical structure) and that has a similar business context (e.g., smart grids for reducing energy costs, supply chain enhancement, and profit maximization in algorithmic trading). In some examples, the system may create prompts for one or more of the respective LLM agents using a respective subset of information associated with one or more example optimization problems that is relevant to the given LLM agent's task.

According to an aspect, a system may receive an input from a user. The input may include a natural language description specifying one or more characteristics of an optimization problem. The input may also include a dataset specifying additional characteristics of the optimization problem. The system may process the user input to generate one or more embeddings, which may be lower-dimensional representations that capture rich semantic information about the user input. Using the one or more embeddings, the system may query a database (e.g., a vector database) to identify one or more example optimization problems (e.g., based on a similarity to the user input). The system may retrieve information (e.g., example prompts) associated with one or more of the identified example optimization problems from the database and/or from another data storage location and generate prompts for the LLM agents using the retrieved information associated with example optimization problems.

The system may generate a plurality of few-shot prompts for a plurality of LLM agents based on the user input and the one or more example optimization problems (or information associated with said example optimization problems). In some examples, the system generates a different few-shot prompt for each LLM agent, using a different subset of information retrieved (e.g., from the database). The subset of information used to generate the few-shot prompt for a respective LLM agent may be determined based on the task assigned to that LLM agent. The tasks assigned to respective LLM agents may include extracting parameters, an objective, decision variables, and/or constraints from the user input, formulating an algorithmic representation of the optimization problem specified by the user input, and/or generating computer executable code specifying characteristics of the optimization problem. The subsets of information used to generate prompts for the respective LLM agents may include corresponding information from the example optimization problem(s) (e.g., decision variables from an example optimization problem may be used to generate the prompt for an LLM agent configured to extract decision variables from a user input).

A respective one (or more) of the plurality of generated prompts may be input into each of the plurality of LLM agents and the plurality of LLM agents may work together to generate computer executable code specifying one or more characteristics of the optimization problem. The system may input the generated code into a solver (e.g., a classical solver or quantum solver) to generate a solution to the optimization problem, which may be output to a user and/or used to configure a computing system to maximize or minimize a value (e.g., monetary cost, energy, material, time, distance, and computing resources).

The techniques disclosed herein provide numerous technical advantages. For instance, transforming natural language descriptions of optimization problems into computer executable code using LLM agents enables users reduces the need for expertise in mathematics and/or machine learning to obtain the benefits of the systems and methods disclosed herein. The systems and methods disclosed herein thus enable developers to express their intentions in natural language and receive code output. Moreover, LLMs are conventionally susceptible to hallucinations and have restricted knowledge update capabilities, which can result in inaccurate optimization model formulations. Furthermore, the performance of LLMs tends to degrade as the system scales to larger problem sizes and complexities, posing a challenge for their application in industrial settings. Dynamic few-shot prompting, according to the techniques disclosed herein, involves providing the LLMs with a relatively small number of carefully selected examples (shots), tailored to the specific optimization problem at hand. This approach is particularly advantageous as it enables the model to comprehend and adapt to new tasks with minimal data, rendering it both highly efficient and versatile. By utilizing few-shot prompts from a database (e.g., a vector database), users can attain high-quality results without the necessity for extensive training datasets, thereby conserving time and computational resources. Furthermore, few-shot prompting enhances the model's capability to generalize from limited examples, resulting in more accurate and contextually relevant outputs. In conclusion, the automated dynamic few-shot prompting enables LLMs to efficiently handle complex queries with greater precision. This approach is also notably efficient, as it is adaptable to the current language models'context length constraints, thus enabling the optimal allocation of computational resources and network bandwidth in distributed systems.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

### Exemplary System for Solving Optimization Problems

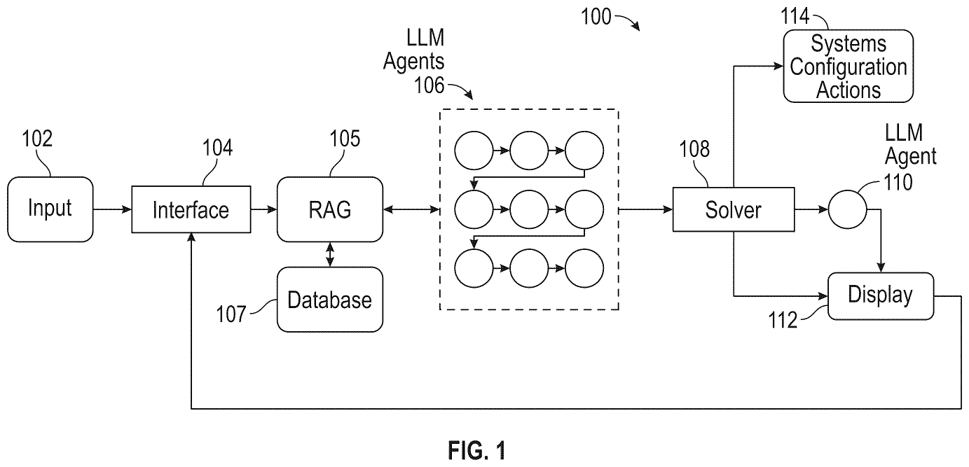

FIG. 1 illustrates an exemplary block diagram representing a computing system 100 for solving optimization problems using a plurality of large language model (LLM) agents 106 and a solver 108. Computing system 100 is configured to receive an input 102. The input 102 may be received by system 100 via an interactive user interface 104. The interactive user interface 104 may include a graphical user interface configured to receive user inputs 102. An input 102 may specify one or more characteristics of an optimization problem. The inputs 102 may include, but is not limited to, a natural language description of an optimization problem, an audio description of an optimization problem, one or more datasets associated with an optimization problem, and/or other data (e.g., images, video, . csv files, etc.). The user interface 104 may also be configured to enable a user to select a type of solver for the optimization problem (e.g., a classical solver or a quantum solver).

The plurality of LLM agents 106 process the input 102 to generate computer executable code specifying characteristics of the optimization problem described in an input 102. The computer executable code may be configured to be executed by a classical solver and/or quantum solver. Each of the plurality of LLM agents 106 may be configured (e.g., prompted) to perform a respective task within a processing pipeline via few-shot prompts generated via a retrieval-augmented-generation (RAG) component 105 of system 100. The RAG component 105 of system 100 may query a knowledge base 107 (e.g., including a vector database) to retrieve information associated with one or more example optimization problems similar to the optimization problem described in an input 102. The knowledge base 107 may be or include a vector database and may store information including example prompts for example optimization problems (including mathematical context and business context). The knowledge base 107 may be leveraged by system 100 to enhance the accuracy and performance of the LLM agents 106 in solving optimization problems.

The RAG component 105 may create few-shot prompts that include information from the one or more example optimization problems, information from input 102, and/or information from the output of one or more of the LLM agents. Information retrieved from the knowledge base 107 may be incorporated into a prompt for one or more LLM agents using predefined rules. For instance, retrieved information may be provided as an example at the bottom of a prompt to let the respective LLM agent understand the intended response to a similar problem statement. Some aspects of the prompts for the respective LLM agents may be hard-coded (e.g., an aspect of a prompt may instruct one of the LLM agents that its role is to extract parameters from a user input) while other aspects of the prompt may be dynamically configured (e.g., by incorporating information retrieved from knowledge base 107 and/or information generated using an LLM into the prompt). Each few-shot prompt may be created using a different subset of information associated with the one or more example optimization problems. Some LLM agent(s) may be prompted using examples of code associated with similar optimization problems to teach the LLM agents to generate code specifying aspects of an optimization problem for input into a solver, while other LLM agent(s) may be prompted using examples of variables, constraints, etc., from one or more example optimization problems to teach the LLM agent to extract variables, constraints, etc., from an input 102.

In some examples, system 100 may additionally employ hypothetical document embedding (HyDE) techniques to enrich the retrieved information associated with example optimization problems. Synthetic data may be generated using a generative AI model (e.g., an LLM) and may be used along with data retrieved from knowledge base 107 to prompt one or more LLM agents 106 (e.g., to generate computer executable code for solving an optimization problem specified by input 102). Thus, system 100 enables autonomous and automated optimization of computer executable code tailored to particular optimization problems based on a type of optimization problem, business context associated with the optimization problem, mathematical context associated with the optimization problem, and/or other factors. Dynamic few-shot prompting achieved using the RAG component 105 not only preserves the efficiency and effectiveness off few-shot learning but also improves the model's capacity to produce accurate and contextually appropriate responses.

The computer executable code generated using the plurality of LLM agents 106 may be input into the solver 108 to generate a solution to the optimization problem. The solver 108 may generate and output a solution to the problem. The solver 108 may be or include a classical solver or quantum solver configured to solve optimization problems. The solver may include a D-Wave Leap Hybrid Solver, or other quantum solver. The solution may correspond to a configuration with the lowest energy of a plurality of configurations. The output may include the energy and one or more corresponding spin configurations. The solution may be provided to a user via interface 104 of computing system 100. In some examples, the solution is input into an LLM agent 110 configured to generate a report based on the solution. The report may be a natural language explanation of the solution to the optimization problem specified by input 102 and may be displayed to a user via the interface 104. The report may include recommended action items to be executed based on the solution.

In some examples, information associated with the optimization problems solved using system 100 (and/or any of the systems and methods disclosed herein) may be stored in the knowledge base 107 such that the system can iteratively/continuously improve in its ability to transform natural language inputs into computer executable code to solve optimization problems. The information may include user inputs, outputs of one or more LLM agents (e.g., optimization objectives, parameters, constraints, algorithmic formulations, code, etc.), solutions to the optimization problems, etc. In some examples, the system may update embeddings stored in a vector database and/or add new embeddings to the vector database that include information associated with the optimization problems solved using system 100.

In some examples, the solver 108 may be part of system 100 and in other examples the solver 108 may be external to system 100. In some examples, the solver 108 may be hosted on the same computing device as the LLM agents 106. In some examples, the LLM agents 106 and/or the solver 108 may reside on the cloud. In some examples, the plurality of LLM agents 106 may be configured to operate locally at one or more client devices (e.g., a desktop computer, mobile phone, laptop, etc.) and/or at one or more remote servers (e.g., on the cloud). The plurality of LLM agents 106 may utilize a combination of computing resources from one or more client devices and one or more remote servers. Computer executable code generated using the plurality of LLM agents may be transmitted over a network from a first computing device to a second computing device hosting the solver using any electronic communications protocol. In some examples, the plurality of LLM agents 106 and the solver 108 may run at the same server or a different server.

The plurality of agents 106 may be arranged in series and/or in parallel with one another in order to apply a plurality of sub-transformations (e.g., in series with one another) to transform the input 102 into computer executable code. In some examples, only a subset of the LLM agents are invoked to transform the input 102 into computer executable code. In some examples, LLM agents may be configured to perform multiple tasks. For instance, an LLM agent may be configured to both generate an algorithmic formulation of a prompt and generate code based on the mathematical formulation.

Computing system 100, or a user thereof, may execute various systems configuration actions 114 based on the solution to the optimization problem. For example, the solution to the optimization problem may include a system configuration that maximizes or minimizes a value based on an objective of the optimization problem. The value may include, for instance, monetary cost, energy resources, material consumption, computing resource utilization, time, distance, or any other value. In some examples, system 100 automatically provisions a computational resource based on the solution to the optimization problem, automatically establishes a network connection based on the solution to the optimization problem, and/or automatically sends a control signal to an electromechanical device based on the solution to the optimization problem. System 100 may be used to solve any type of optimization problem, for instance, including combinatorial optimization problems (e.g., traveling salesman problem and/or other “NP-hard” optimization problems), convex optimization problems, non-convex optimization problems, constrained optimization problems, stochastic optimization problems, discrete optimization problems, continuous optimization problems, linear optimization problems, non-linear optimization problems, and/or any other type of optimization problem(s).

### Exemplary Method for Creating a Vector Database

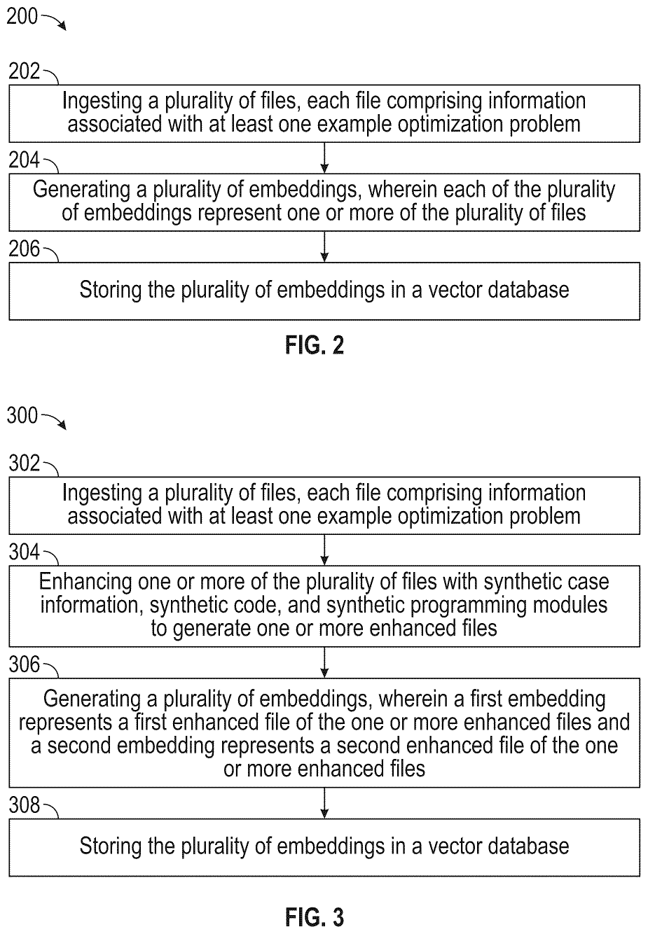

FIG. 2 illustrates an exemplary method 200 for creating a vector database that may be used according to the systems and methods herein to solve optimization problems. Method 200 may be performed using any or all of the aspects described above with reference to FIG. 1. Method 200 is performed, for example, using one or more electronic devices implementing a software platform. In some examples, method 200 is performed using a client-server system, and the steps of process 200 are divided up in any manner between the server and one or more client devices. In other examples, method 200 is performed using only a client device or only multiple client devices. In method 200, some steps are, optionally, combined, the order of some steps is, optionally, changed, and some steps are, optionally, omitted. In some examples, additional steps may be performed in combination with the method 200. Accordingly, the operations as illustrated (and described in greater detail below) are exemplary by nature and, as such, should not be viewed as limiting.

At block 202, an exemplary system (e.g., one or more electronic devices) may ingest a plurality of files, each file including information associated with at least one example optimization problem. One or more of the plurality of files may include computer executable code associated with an optimization problem, context, such as business context associated with the optimization problem and/or mathematical context associated with the optimization problem (e.g., one or more mathematical/algorithmic representations of the optimization problem). For instance, context for a traveling salesman problem may include: “the Traveling Salesman Problem (TSP) is a classic optimization problem in which a salesman is required to visit a set of cities exactly once and return to the starting city. The goal is to determine the shortest possible route that visits each city once and minimizes the total travel distance or cost.” As another example, context associated with a knapsack problem may include: “given a set of items, each with a specific weight and value, and a knapsack with a maximum weight capacity, the objective is to determine the optimal combination of items to include in the knapsack. The total weight of the selected items must not exceed the knapsack's capacity, and the total value should be maximized.”

Each of the plurality of files may include information associated with a respective type of optimization problem. For instance, the system may ingest files associated with combinatorial optimization problems (e.g., traveling salesman problem and/or other “NP-hard” optimization problems), convex optimization problems, non-convex optimization problems, constrained optimization problems, stochastic optimization problems, discrete optimization problems, continuous optimization problems, linear optimization problems, non-linear optimization problems, and/or any other type of optimization problem(s).

At block 204, the exemplary system may generate a plurality of embeddings. Each of the plurality of embeddings may represent one or more of the plurality of files. The embeddings may be generated using an embedding model (e.g., a machine learning model) and may capture rich semantic information included in one or more or the plurality of files. For instance, the embedding model may encode the computer executable code associated with the optimization problem, business context associated with the optimization problem, mathematical context associated with the optimization problem (e.g., one or more mathematical/algorithmic representations of the optimization problem), and/or other information into one or more embedding vectors that can be stored in a vector database.

In some examples, a respective problem statement associated with each of the example optimization problems is encoded into an embedding. The problem statement may be enriched (e.g., using an LLM or by a human) to include synonyms and other context associated with the problem statement. For example, an unenriched problem statement for a traveling salesman problem may be “given a list of cities and the distances between them, what is the shortest possible route that visits each city exactly once and returns to the origin city?” An enriched version of that problem statement may be, for illustrative purposes, “Travelling Salesman problem, consider a scenario where an agent (e.g., a salesperson, courier, driver, or delivery person) needs to deliver packages (or shipments or couriers) from a warehouse (or distribution center, depot, or home base) to a set of distinct locations (cities, nodes, or points) exactly once and then return to the original starting point. The distances (or costs, travel times, or metrics) between every pair of these locations are provided by the user in the form of a distance matrix (or cost matrix). The goal is to find the shortest possible route (also known as a circuit, cycle, tour, or Hamiltonian cycle) that visits all locations exactly once and returns to the start, minimizing the total travel distance (or overall cost).” The enriched version of the problem statement may be encoded into an embedding and stored in a vector database, as discussed below. The remaining information (e.g., example prompts for determining parameters, constraints, etc., using one or more LLM agents) from the file associated with the respective example optimization problem may be accessed using a file location stored in metadata of the embedding. In some examples, each example optimization problem (e.g., each file) may be encoded into multiple embeddings. For instance, the embedding model may generate a parameters embedding, an objective embedding, a constraints embedding, an objective formulation embedding, a constraint formulation embedding, etc., for each example optimization problem.

At block 206, the exemplary system may store the generated plurality of embeddings in a vector database. The system may index the generated embeddings within the vector database using flat indexing, graph indexing, inverted indexing, or another indexing method. The vector database may enable the system to identify one or more embeddings within the vector database that are similar to an embedding representing a user query, for instance, based on cosine similarity, Euclidean distance, etc. The vector database may enable the system to associate at least a first embedding of the plurality of embeddings with at least a second embedding of the plurality of embeddings in a vector database (e.g., when a user queries the vector database).

Thus, the exemplary system may create a searchable vector database in which embedding representations of a plurality of different optimization problems are associated within the database according to semantic similarity between the respective embeddings. When a user utilizes the system disclosed herein to solve optimization problems, the system may compare the optimization problem described by the user (e.g., an embedding representation of the problem statement provided by the user) to the embedding representations of the example optimization problems stored in the vector database to identify similar problems. Searching the vector database may involve measuring a similarity between different embeddings (e.g., cosine similarity, Euclidean distance, etc.) to identify embeddings similar to one or more embeddings representing a user input.

In some examples, an embedding representation of the user input problem statement is compared to embedding representations of the example optimization problem statements. Once one or more similar example problem statement embeddings are identified, the system may retrieve additional information associated with the identified example optimization problem(s) using a file location identifier/indicator stored in metadata of the one or more embeddings. The additional information may include example prompts for determining parameters, constraints, optimization objectives, algorithmic formulations, computer executable code, etc., as discussed herein. By utilizing embedding representations of the problem statements (e.g., as opposed to multiple embedding representations corresponding to different portions of the example optimization problems (e.g., parameters, constraints, etc.), the vector database may only need to be queried once.

In some examples, however, the system may additionally, or alternatively, encode other information from each example optimization problem (e.g., each file) into multiple embeddings. For instance, the embedding model may generate a parameters embedding, an objective embedding, a constraints embedding, an objective formulation embedding, a constraint formulation embedding, etc., for each example optimization problem. In such examples, the system may query the vector database multiple times, for instance, to create a respective prompt for each of the LLM agents. The system may generate a plurality of queries by embedding information from the output of one or more of the LLM agents and/or the user input to compare to the multiple embedding representations for each example optimization problems in the vector database. For instance, distinct queries may be executed to separately obtain example parameters, example optimization objectives, example variables, example constraints, example algorithmic formulations, example code, etc. The system can then generate prompts (e.g., few-shot prompting) using the information associated with one or more of the embeddings stored in the vector database to teach LLM agents how to construct computer executable code for solving the optimization problem described by the user.

FIG. 3 illustrates an exemplary method 300 for creating a vector database using files associated with optimization problems that have been enhanced with synthetic data generated using a generative AI model (e.g., an LLM). Method 300 may be performed using any or all of the aspects described above with reference to FIGS. 1 and 2. Method 300 is performed, for example, using one or more electronic devices implementing a software platform. In some examples, method 300 is performed using a client-server system, and the steps of process 300 are divided up in any manner between the server and one or more client devices. In other examples, method 300 is performed using only a client device or only multiple client devices. In method 300, some steps are, optionally, combined, the order of some steps is, optionally, changed, and some steps are, optionally, omitted. In some examples, additional steps may be performed in combination with the method 300. Accordingly, the operations as illustrated (and described in greater detail below) are exemplary by nature and, as such, should not be viewed as limiting.

At block 302, an exemplary system (e.g., one or more electronic devices) may ingest a plurality of files, each file including information associated with at least one example optimization problem. The ingested files may include any of the information described above with reference to method 200. One or more of the plurality of files may include computer executable code associated with an optimization problem, business context associated with the optimization problem, mathematical context associated with the optimization problem (e.g., one or more mathematical/algorithmic representations of the optimization problem). Each of the plurality of files may include information associated with a respective type of optimization problem. For instance, the system may ingest files associated with combinatorial optimization problems (e.g., traveling salesman problem and/or other “NP-hard” optimization problems), convex optimization problems, non-convex optimization problems, constrained optimization problems, stochastic optimization problems, discrete optimization problems, continuous optimization problems, linear optimization problems, non-linear optimization problems, and/or any other type of optimization problem(s).

At block 304, the exemplary system may enhance one or more of the plurality of files with synthetic data. The synthetic data may include, but is not limited to, synthetic case information, synthetic business context, synthetic code, and synthetic programming modules to generate one or more enhanced files. The synthetic case information, synthetic business context, synthetic code, and synthetic programming modules may be generated using a generative AI model, such as a large language model (LLM). The synthetic data may provide a more comprehensive representation describing a type of optimization problem, for instance, within a particular business context, along with techniques (e.g., mathematical/algorithmic context) for solving such an optimization problem.

At block 306, the exemplary system may generate a plurality of embeddings. A first embedding may be generated that represents a first enhanced file of the one or more enhanced files and a second embedding may be generated that represents a second enhanced file of the one or more enhanced files. Each of the plurality of embeddings may represent a respective one or more of the plurality of files. The embeddings may be generated using an embedding model (e.g., a machine learning model) and may capture rich semantic information included in one or more or the plurality of enhanced files. For instance, the embedding model may encode the information included in the ingested plurality of files and the synthetic data included in the enhanced plurality of files into the plurality of embeddings. Thus, the embedding model may generate embedding vectors capturing various information about how to algorithmically construct and solve optimization problems for a variety of optimization problem types, and those embeddings can be stored in a searchable vector database.

At block 308, the exemplary system may store the plurality of embeddings in a vector database. The system may index the generated embeddings within the vector database using flat indexing, graph indexing, inverted indexing, or another indexing method. The vector database may enable the system to identify one or more embeddings within the vector database that are similar to an embedding representing a user query, for instance, based on cosine similarity, Euclidean distance, etc. The vector database may enable the system to associate at least a first embedding of the plurality of embeddings with at least a second embedding of the plurality of embeddings in a vector database (e.g., when a user queries the vector database).

Thus, the exemplary system may create a searchable vector database in which embedding representations of a plurality of different optimization problems are associated within the database according to semantic similarity between the respective embeddings. When a user utilizes the system disclosed herein to solve optimization problems, the system may compare the optimization problem described by the user to those stored in the vector database to identify similar problems. The system can then generate prompts (e.g., few-shot prompting) using one or more of the embeddings stopped in the vector database to teach LLM agents how to construct computer executable code for solving the optimization problem described by the user.

### Exemplary Method for Solving Optimization Problems

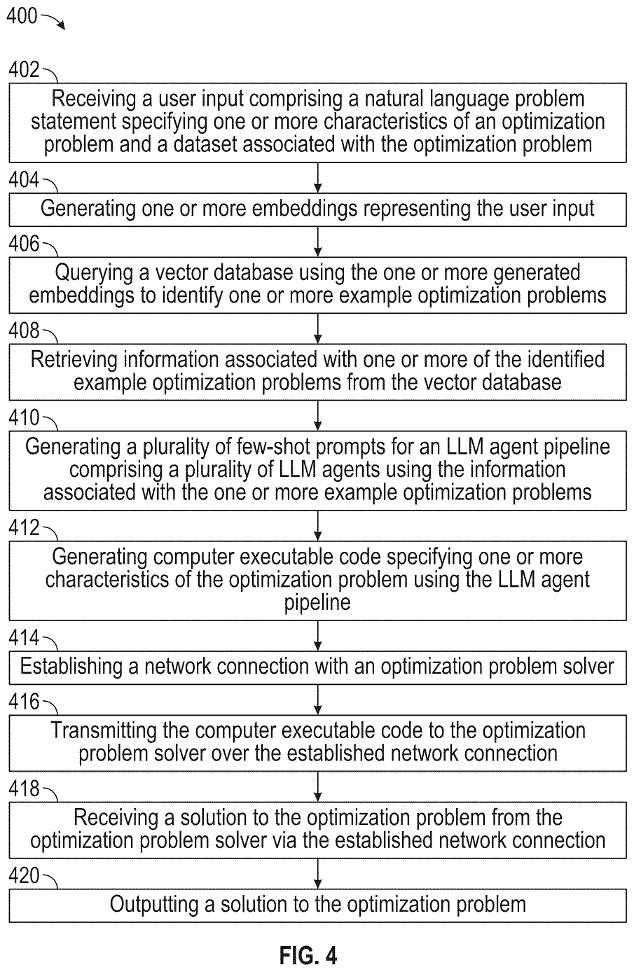

FIG. 4 illustrates an exemplary method 400 for solving an optimization problem using a plurality of LLM agents. Method 400 may be performed using any or all of the aspects described above with reference to FIGS. 1-3B. Method 400 is performed, for example, using one or more electronic devices implementing a software platform. In some examples, method 400 is performed using a client-server system, and the steps of process 400 are divided up in any manner between the server and one or more client devices. In other examples, method 400 is performed using only a client device or only multiple client devices. In method 400, some steps are, optionally, combined, the order of some steps is, optionally, changed, and some steps are, optionally, omitted. In some examples, additional steps may be performed in combination with the method 400. Accordingly, the operations as illustrated (and described in greater detail below) are exemplary by nature and, as such, should not be viewed as limiting.

At block 402, an exemplary system (e.g., one or more electronic devices) may receive an input specifying one or more characteristics of the optimization problem. The input may include a natural language problem statement specifying one or more characteristics of the optimization problem. The input may also include a dataset associated with the optimization problem. The input may be received via an interactive user interface. The input may include audio data or other media data. The dataset associated with the optimization problem may include structured data, etc. (e.g., images, video, . csv files, etc.). The dataset may include, for instance, variable symbols, parameter symbols, etc., which may enable the system to more accurately transform the input into computer executable code for solving the optimization problem. The input may include a request that a certain value be minimize or maximized (e.g., “find the shortest route”). The input may specify one or more characteristics of an optimization problem that can be solved using a quantum solver or classical solver.

At block 404, the exemplary system may generate one or more embeddings representing the input received at block 402. The embeddings may be generated using an embedding model (e.g., a machine learning model) trained to capture rich semantic information about the input within a lower-dimensional embedding vector. The one or more generated embeddings may represent the natural language problem statement and/or the dataset received at block 402.

At block 406, the exemplary system may query a vector database (e.g., such as the vector database generated according to process 300A and/or process 300B) using the one or more generated embeddings. The system may compare the one or more generated embeddings that represent characteristics of the optimization problem described in the input to one or more embeddings stored in the vector database (e.g., the embeddings described according to process 300A and/or process 300B). The system may identify one or more embeddings in the vector database representing information associated with one or more example optimization problems based on a similarity (e.g., cosine similarity, Euclidean distance, semantic similarity) between the one or more example optimization problems and the one or more embeddings representing the input received at block 402.

In some examples, the generated embeddings are compared to an embedding representation of a problem statement stored in association with the example optimization problems in the vector database. In some examples, a respective problem statement associated with each of a plurality of example optimization problems is encoded into a respective embedding and stored in the vector database. The problem statements associated with the example optimization problems may be enriched (e.g., using an LLM or by a human, for instance, as discussed with reference to FIG. 2) to include synonyms and other context associated with the problem statement. The enriched version of the problem statement may be encoded into an embedding and stored in the vector database. Additional information associated with respective example optimization problems (e.g., example prompts for determining parameters, constraints, etc., using one or more LLM agents) may be accessed by the system (e.g., to retrieve the information and incorporate it into prompts for LLM agents) using a file location indicator stored in metadata of the respective embeddings.

Comparisons between embedding representations of user defined problem statements and problem statements associated with example optimization problems may enable the system to more accurately identify example optimization problems relevant to the problem the user desires to solve. Thus, the system may identify example optimization problems similar to the input received at block 402 that will be helpful for constructing and solving the optimization problem received at block 402.

At block 408, the exemplary system may retrieve information associated with the one or more of the identified example optimization problems. The information may be retrieved from the vector database or other data storage location accessible by the system (e.g., using the file location indicator stored in metadata of the embedding) For example, the system may retrieve computer executable code associated with an example optimization problem, business context associated with the example optimization problem, mathematical context associated with the example optimization problem (e.g., one or more mathematical/algorithmic representations of the optimization problem). Some of the retrieved information may include synthetic data that was generated using a generative AI model (e.g., LLM), such as synthetic business context, synthetic computer executable code, synthetic mathematical context, and synthetic programming modules (e.g., libraries) may be generated using a generative AI model, such as a large language model (LLM). In some examples, the system may employ hypothetical document embedding (HyDE) techniques to enrich the retrieved information with synthetic data that may be generated using a generative AI model (e.g., an LLM) and may be used along with data retrieved from the vector database to prompt one or more LLM agents to generate computer executable code for solving an optimization problem specified by the input received at block 402.

At block 410, the exemplary system may generate a plurality of few-shot prompts for an LLM agent pipeline comprising a plurality of LLM agents. One or more of the plurality of few-shot prompts may be generated using the user input and/or the information associated with the one or more example optimization problems. Any or all of the LLM agents used by the exemplary system may be configured to perform their respective tasks via few-shot prompting, which provides the LLM agents with one or more examples from similar optimization problems to guide the LLM agent's output, allowing the LLM agent to improve its performance for its respective task with minimal training data. The system may input each of the plurality of few-shot prompts into a respective one of the plurality of LLM agents such that each LLM agent (or different subsets of LLM agents) may receive one of the plurality of few-shot prompts generated via retrieval augmentation generation (RAG). RAG involves obtaining data from a knowledge base (e.g., from a file location indicated by the vector database as described at block 408) and generating an enhanced prompt using the retrieved information and the original input (e.g., the few-shot prompts generated at block 410).

In some examples, each LLM agent (or different subsets of LLM agents) receives a distinct few-shot prompt generated based on a respective portion of the information retrieved using the vector database at block 408. For instance, in some examples, a first few-shot prompt for at least a first LLM agent is generated based on the user input and a first subset of information from at least one of the one or more example optimization problems, a second few-shot prompt for at least a second LLM agent based on an output of at least the first LLM agent and a second subset of information from at least one of the one or more example optimization problems, and a third few-shot prompt for at least a third LLM agent based on an output of at least the second LLM agent and a third subset of information from at least one of the one or more example optimization problems. The first subset of information may include any one or more of parameters, an objective, decision variables, and constraints associated with the at least one example optimization problem. The second subset of information may include an algorithmic representation of the at least one example optimization problem. The third subset of information may include computer executable code for the at least one example optimization problem. Accordingly, each of the LLM agents may be optimized, via few-shot prompting, to perform a respective task withing a processing pipeline of LLM agents that gradually convert a user input into computer executable code representing an optimization problem that can be input into an optimization problem solver.

At block 412, the exemplary system may generate computer executable code specifying one or more characteristics of the optimization problem using the LLM agent pipeline. The computer executable code may be generated using each of the plurality of LLM agents and the plurality of few-shot prompts. For instance, each of the plurality of LLM agents may be configured using a respective few-shot prompt to perform a respective task that contributes to transforming a user input into computer executable code. The plurality of LLM agents may work together, each performing distinct tasks, to transform the input into code. One or more of the LLM agents may be capable of operating in sequence or in parallel with one or more of the other LLM agents.

As discussed above, the system may input a few-shot prompt generated using a subset of information associated with one or more example optimization problems retrieved using the vector database into each of the plurality of LLM agents. The system may dynamically generate each prompt for one or more of the LLM agents using the relevant subset of information associated with one or more example optimization problems for that LLM agent and the output of one or more of the previous LLM agents. For example, as discussed above, the system may generate a first few-shot prompt for at least a first LLM agent or subset of LLM agents based on the input received at block 402 and a first subset of information from at least one of the one or more example optimization problems. The first LLM agent or subset of LLM agents may generate an output, and the system may generate a second few-shot prompt using the output from the first LLM agent or subset of LLM agents and a second subset of information from at least one of the one or more example optimization problems. The second few-shot prompt may then be input into a subsequent LLM agent in the pipeline. The system may continue this process for a third LLM agent, fourth LLM agent, and so on. In some examples, the first LLM agent or subset of LLM agents is configured (e.g., using a respective few-shot prompt) to extract any one or more of parameters, an objective, decision variables, and constraints from the user input. In some examples, a second LLM agent or subset of LLM agents is configured to formulate an algorithmic representation of the user input. In some examples, a third LLM agent or subset of LLM agents is configured to generate computer executable code representing the user input.

In some examples, a parameter extraction LLM agent extracts a plurality of parameters from the user input received at block 402 and assigns a corresponding symbol to each of the plurality of parameters (e.g., “number of locations,” “starting location,” “distance between locations” for an example traveling salesman problem). The system may generate a few-shot prompt for the parameter extraction LLM agent using the user input received at block 402 and a subset of information obtained from one or more example optimization problems retrieved using the vector database (e.g., from the vector database or from a data storage location indicated by a file location indicator stored in metadata of an embedding in the vector database). For instance, the system may generate a few-shot prompt that includes information from a natural language portion of the input received at block 402, a dataset received at block 402, and/or parameters associated with one or more exemplary optimization problems from the vector database. The parameters associated with one or more exemplary optimization problems from the vector database may include symbols, shapes, and definitions. The few-shot prompt, including parameters (and/or other relevant information) associated with one or more exemplary optimization problems from the vector database may teach the parameters extraction LLM agent to extract a plurality of parameters from the user input received at block 402 and assign a corresponding symbol to each of the plurality of parameters.

A problem formatter LLM agent may replace each of the plurality of parameters in the prompt with the corresponding symbol to generate a formatted problem statement. The system may generate a few-shot prompt for the problem formatter LLM agent using the user input received at block 402, the output of the parameter extraction LLM agent, and/or a subset of information obtained from one or more example optimization problems retrieved using the vector database (e.g., from the vector database or from a data storage location indicated by a file location indicator stored in metadata of an embedding in the vector database). For instance, the system may generate a few-shot prompt that includes information from a natural language portion of the input received at block 402, the dataset received at block 402, information from the output of the parameter extraction LLM agent, and/or one or more formatted problem statements associated with one or more exemplary optimization problems from the vector database. The few-shot prompt, including one or more formatted problem statements associated with one or more exemplary optimization problems from the vector database may teach the problem formatter LLM agent to properly format a problem statement by replacing each of the plurality of parameters in the user input with the corresponding symbol to generate a formatted problem statement.

An objective and variable extraction LLM agent may determine an optimization objective and may determine one or more decision variables. The system may generate a few-shot prompt for the objective and variable extraction LLM agent using the user input received at block 402, the output of the parameter extraction LLM agent, the output of the problem formatter LLM agent, and/or a subset of information obtained from one or more example optimization problems retrieved from the vector database (e.g., from the vector database or from a data storage location indicated by a file location indicator stored in metadata of an embedding in the vector database). For instance, the system may generate a few-shot prompt that includes information from a natural language portion of the input received at block 402, information from the dataset received at block 402, information from the output of the parameter extraction LLM agent and/or problem formatter LLM agent, and/or objectives and/or decision variables associated with one or more exemplary optimization problem from the vector database. The few-shot prompt, including one or more objectives and/or decision variables associated with one or more exemplary optimization problem from the vector database may teach the objective and variable extraction LLM to properly generate an objective description, objective context, and/or decision variable (including a variable symbol, variable shape, and/or variable definition).

A constraints extraction LLM agent may determine one or more constraints for the optimization problem based at least in part on the prompt and the plurality of parameters. The system may generate a few-shot prompt for the constraints extraction LLM agent using the user input received at block 402, the output of the objective and variable extraction LLM agent, the output of the parameter extraction LLM agent, the output of the problem formatter LLM agent, and/or a subset of information obtained from one or more example optimization problems retrieved from the vector database (e.g., from the vector database or from a data storage location indicated by a file location indicator stored in metadata of an embedding in the vector database). For instance, the system may generate a few-shot prompt that includes information from a natural language portion of the input received at block 402, information from the dataset received at block 402, information from the output of the objective and variable extraction LLM agent, information from the output of the parameter extraction LLM agent, information from the output of the problem formatter LLM agent, and/or constraints associated with one or more exemplary optimization problem from the vector database. The few-shot prompt, including one or more constraints (e.g., natural language and/or algorithmic representations of constraints, such as “each location appears only once for every path j except the last visitation sequence when it will visit the starting city again,” in an exemplary traveling salesman problem, etc.) associated with one or more exemplary optimization problem from the vector database may teach the constraints extraction LLM agent to properly generate constraints for the optimization problem (including a natural language and/or algorithmic description of the constraints).

An objective formulator LLM agent may generate an algorithmic/mathematical representation of the optimization objective associated with the optimization problem. The system may generate a few-shot prompt for the objective formulator LLM agent using the user input received at block 402, the output of the constraints extraction LLM agent, the output of the objective and variable extraction LLM agent, the output of the parameter extraction LLM agent, the output of the problem formatter LLM agent, and/or a subset of information obtained from one or more example optimization problems retrieved from the vector database (e.g., from the vector database or from a data storage location indicated by a file location indicator stored in metadata of an embedding in the vector database). For instance, the system may generate a few-shot prompt that includes information from a natural language portion of the input received at block 402, information from the dataset received at block 402, information from the output of the constraints extraction LLM agent, information from the output of the objective and variable extraction LLM agent, information from the output of the parameter extraction LLM agent, information from the output of the problem formatter LLM agent, and/or mathematical/algorithmic representations of optimization objectives associated with one or more exemplary optimization problems from the vector database. The few-shot prompt, including a mathematical/algorithmic representation of an optimization objective associated with one or more exemplary optimization problems from the vector database may teach the objective formulator LLM agent to properly formulate an algorithmic/mathematical representation of the optimization objective for the optimization problem.

A constraints formulator LLM agent may generate an algorithmic/mathematical representation of the one or more constraints. The system may generate a few-shot prompt for the constraints formulator LLM agent using the user input received at block 402, the output of the constraints extraction LLM agent, the output of the objective and variable extraction LLM agent, the output of the parameter extraction LLM agent, the output of the problem formatter LLM agent, and/or a subset of information obtained from one or more example optimization problems retrieved from the vector database (e.g., from the vector database or from a data storage location indicated by a file location indicator stored in metadata of an embedding in the vector database). For instance, the system may generate a few-shot prompt that includes information from a natural language portion of the input received at block 402, information from the dataset received at block 402, information from the output of the constraints extraction LLM agent, information from the output of the objective and variable extraction LLM agent, information from the output of the parameter extraction LLM agent, information from the output of the problem formatter LLM agent, and/or algorithmic representations of constraints associated with one or more exemplary optimization problem from the vector database. The few-shot prompt, including algorithmic representations of constraints associated with one or more exemplary optimization problem from the vector database may teach the constraints formulator LLM agent to properly formulate an algorithmic representation of the constraints for the optimization problem.

A variable code LLM agent may generate computer executable code to solve for the one or more decision variables. The system may generate a few-shot prompt for the variable code LLM agent using the user input received at block 402, the output of the output of the objective and variable extraction LLM agent, the output of any one or more of the other LLM agents, and/or a subset of information obtained from one or more example optimization problems retrieved from the vector database (e.g., from the vector database or from a data storage location indicated by a file location indicator stored in metadata of an embedding in the vector database). For instance, the system may generate a few-shot prompt that includes information from a natural language portion of the input received at block 402, information from the dataset received at block 402, information from the output of the objective formulator LLM agent, information from the output of the constraint formulator LLM agent, information from the output of the constraints extraction LLM agent, information from the output of the objective and variable extraction LLM agent, information from the output of the parameter extraction LLM agent, information from the output of the problem formatter LLM agent, and/or computer executable code for decision variables associated with one or more exemplary optimization problem from the vector database. The few-shot prompt, including computer executable code for decision variables associated with one or more exemplary optimization problem from the vector database may teach the variable code LLM agent to properly generate computer executable code to solve for decision variable associated with the optimization problem.

An objective code LLM agent may generate computer executable code specifying one or more characteristics of the objective using the algorithmic representation of the objective. The system may generate a few-shot prompt for the objective code LLM agent using the user input received at block 402, the output of the output of the objective and variable extraction LLM agent, the output of the objective formulator LLM agent, the output of any one or more of the other LLM agents, and/or a subset of information obtained from one or more example optimization problems retrieved from the vector database (e.g., from the vector database or from a data storage location indicated by a file location indicator stored in metadata of an embedding in the vector database). For instance, the system may generate a few-shot prompt that includes information from a natural language portion of the input received at block 402, information from the dataset received at block 402, information from the output of the objective formulator LLM agent, information from the output of the constraint formulator LLM agent, information from the output of the constraints extraction LLM agent, information from the output of the objective and variable extraction LLM agent, information from the output of the parameter extraction LLM agent, information from the output of the problem formatter LLM agent, and/or computer executable code for an optimization objective associated with one or more exemplary optimization problem from the vector database. The few-shot prompt, including executable code for an optimization objective associated with one or more exemplary optimization problem from the vector database may teach the objective code LLM agent to properly generate computer executable code specifying one or more aspects of an optimization objective associated with the optimization problem.

A constraint code LLM agent may generate quantum annealing code defining the one or more constraints using the mathematical representation of the one or more constraints. The system may generate a few-shot prompt for the constraint code LLM agent using the user input received at block 402, the output of the output of the constraints extraction LLM agent, the output of the constraints formulator LLM agent, the output of any one or more of the other LLM agents, and/or a subset of information obtained from one or more example optimization problems retrieved from the vector database (e.g., from the vector database or from a data storage location indicated by a file location indicator stored in metadata of an embedding in the vector database). For instance, the system may generate a few-shot prompt that includes information from a natural language portion of the input received at block 402, information from the dataset received at block 402, information from the output of the objective formulator LLM agent, information from the output of the constraint formulator LLM agent, information from the output of the constraints extraction LLM agent, information from the output of the objective and variable extraction LLM agent, information from the output of the parameter extraction LLM agent, information from the output of the problem formatter LLM agent, and/or computer executable code for an optimization objective associated with one or more exemplary optimization problem from the vector database. The few-shot prompt, including executable code for constraints associated with one or more exemplary optimization problem from the vector database may teach the objective code LLM agent to properly generate computer executable code specifying one or more aspects of constraints associated with the optimization problem.

The exemplary system performing method 400 may construct finalized computer executable code by combining the outputs of the variable code LLM agent, objective code LLM agent, and/or the constraint code LLM agent. The finalized computer executable code may be executable using an optimization problem solver, such as a classical solver and/or quantum solver. At block 414, the exemplary system may establish a network connection with an optimization problem solver. At block 416, the exemplary system may transmit the computer executable code to the optimization problem solver over the established network connection. The solver may determine a solution to the optimization problem and transmit the solution back to the exemplary system performing method 400. At block 418, the exemplary system may receive a solution to the optimization problem from the optimization problem solver via the established network connection. At block 420, the exemplary system may output a solution to the optimization problem. It should be understood that the solver may instead be run using the same computing system or computing device as the plurality of LLM agents, and in such cases a network connection may not be needed to input the computer executable code into the solver.

In some examples, method 400 includes configuring a computing system to maximize or minimize a value using the solution to the optimization problem. In some examples, the value includes any one or more of: monetary cost, energy, material, time, distance, and computing resources. In some examples, method 400 includes automatically provisioning a computational resource based on the solution to the optimization problem, automatically establishing a network connection based on the solution to the optimization problem, and/or automatically sending a control signal to an electromechanical device based on the solution to the optimization problem.

Method 400 may be used to solve any type of optimization problem, for instance, including combinatorial optimization problems (e.g., traveling salesman problem and/or other “NP-hard” optimization problems), convex optimization problems, non-convex optimization problems, constrained optimization problems, stochastic optimization problems, discrete optimization problems, continuous optimization problems, linear optimization problems, non-linear optimization problems, and/or any other type of optimization problem(s).

### Exemplary GUI for Solving Optimization Problems

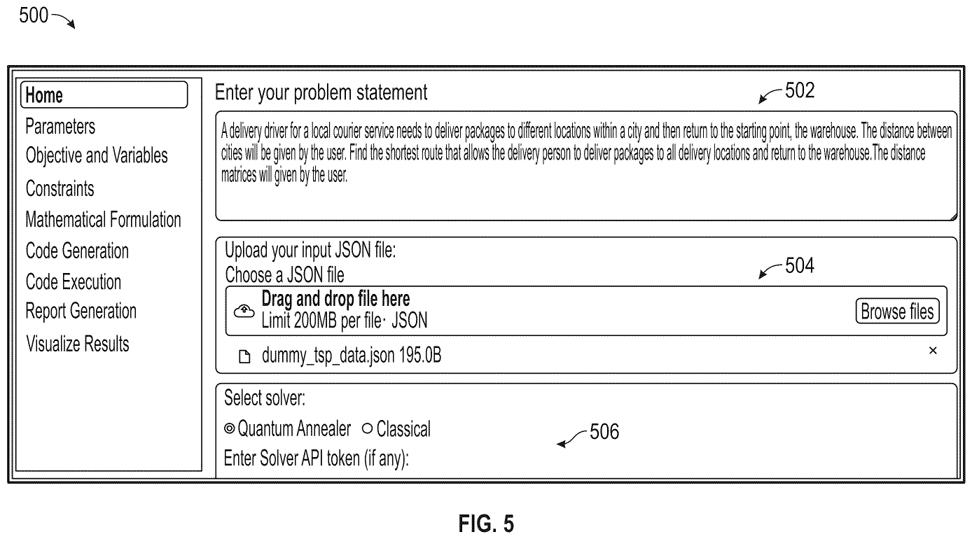

FIGS. 5-15 illustrate aspects of graphical user interfaces (GUIs) that may be implemented in accordance with the examples disclosed herein (e.g., for GUI 104 of FIG. 1). The GUIs shown and described with reference to FIGS. 5-15 are for illustrative purposes only. Various additions and modifications are within the scope of this disclosure. FIG. 5 illustrates an exemplary graphical user interface (GUI) 500 that may be used to implement and/or include one or more of the aspects of the systems and methods described herein. GUI 500 may include a plurality of affordances configured to enable a user to input a prompt/problem statement that specifies one or more aspects of an optimization problem. Affordance 502 enables a user to enter a natural language problem statement that specifies aspects of the optimization problem. Affordance 504 enables a user to upload a file that may include a dataset. The dataset may form part of the input to the one or more LLM agents and/or may be used to perform retrieval-augmented-generation (RAG). Affordance 506 enables a user to select a solver type, such as a quantum solver or classical solver and/or to input an API token to connect to the solver.

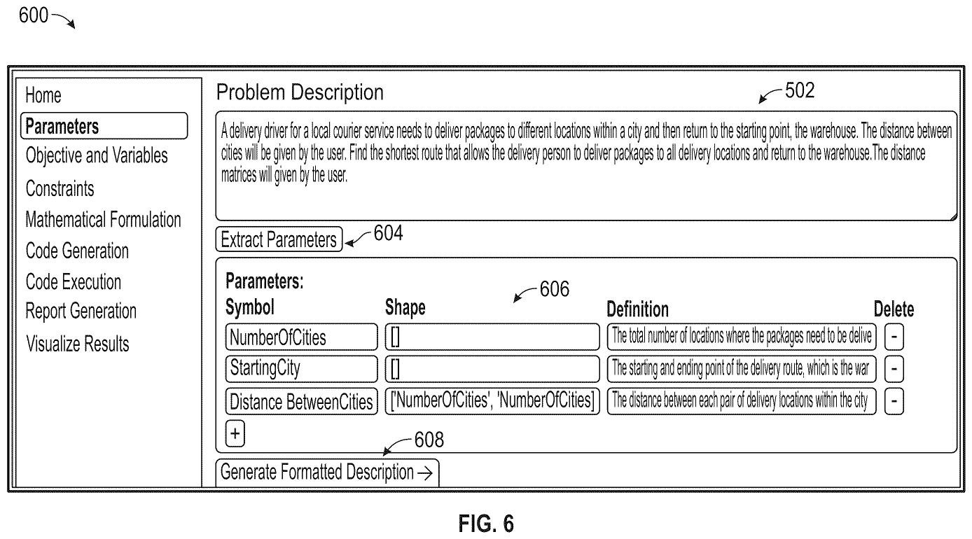

FIG. 6 illustrates aspects of an exemplary GUI 600 that may be used to implement and/or include one or more of the aspects of the systems and methods described herein. GUI 600 may include a plurality of affordances that enable a user to extract one or more parameters from the prompt (e.g., the problem statement 502 received via GUI 500). A user may select affordance 604 to extract the parameters from the problem statement 502. Selecting affordance 604 may cause an exemplary system (e.g., system 100) to input the problem statement 502 into a parameter extraction LLM agent configured to extract the parameters and assign a corresponding symbol to each of the parameters. Selecting affordance 604 may cause an exemplary system to perform RAG to retrieve information associated with one or more example optimization problems similar to the optimization problem specified in problem statement 502 and generate a few-shot prompt to input into the parameter extraction LLM agent. The few-shot prompt generated upon selection of affordance 604 may be input into the parameter extraction LLM agent. The parameters, assigned symbols for each parameter, a shape/dimension of each of the parameters, and a definition of each of the parameters (each generated using the parameter extraction LLM agent) are shown in field 606 of GUI 600 and may be revised and/or deleted by a user via the GUI 600. GUI 600 may enable users to define additional parameters not extracted by the parameter extraction LLM agent. Affordance 608, when selected, may cause the exemplary system to input the problem statement 502 and the extracted parameters into a problem formatter LLM agent configured to replace each of the plurality of parameters in the prompt with the corresponding symbol to generate a formatted problem statement.

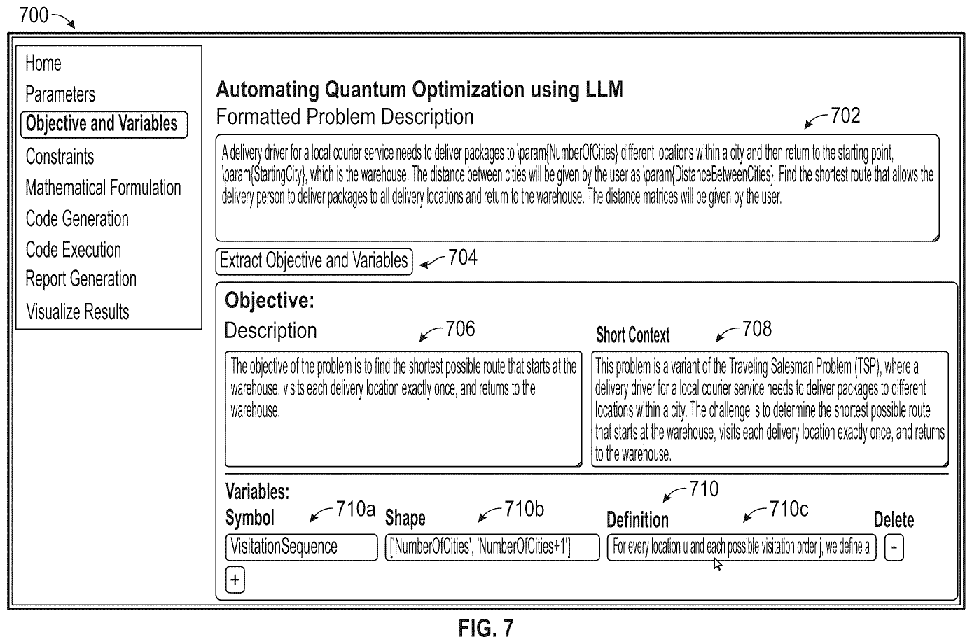

FIG. 7 illustrates aspects of an exemplary GUI 700 that may be used to implement and/or include one or more of the aspects of the systems and methods described herein. An exemplary formatted problem statement 702 generated upon selection of affordance 608 of GUI 600 is shown at the top of GUI 700. GUI 700 may include an affordance 704, which when selected, may cause the system (e.g., system 100) to process the formatted problem statement 702 to determine an objective 706, context 708, and decision variable(s) 710 using an objective and variables extraction LLM agent. Selecting affordance 704 may cause the system to perform RAG to generate a few-shot prompt using information associated with one or more example optimization problems, for instance, including an objective, context, and decision variables associated with the one or more example optimization problems. The few-shot prompt generated upon selection of affordance 704 may be input into the objective and variables extraction LLM agent. The objective and variables extraction LLM agent also assigns symbols 710 a, a shape/dimension 710b, and a definition of the decision variable(s) 710c to the decision variable(s) 710. GUI 700 may be configured such that users can revise the symbol, shape/dimension, and/or definition of the decision variable(s). GUI 700 may also enable users to delete or add decision variable(s).

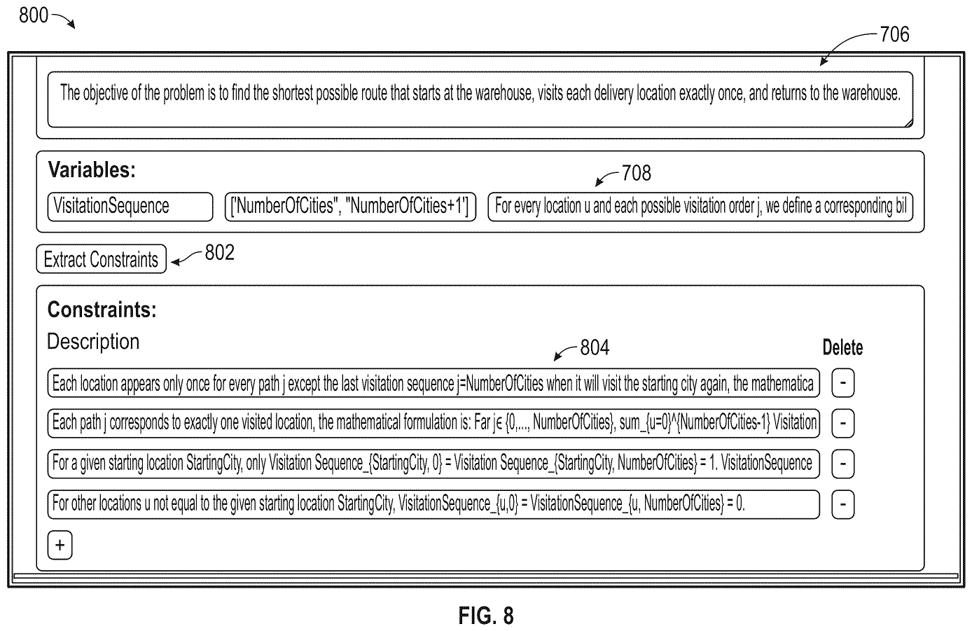

FIG. 8 illustrates aspects of an exemplary GUI 800 that may be used to implement and/or may include one or more of the aspects of the systems and methods described herein. GUI 800 may enable a user to determine one or more constraints for the optimization problem. GUI 800 may include an affordance 802, which when selected, may cause the system to determine one or more constraints 804 for the optimization problem using a constraints extraction LLM agent. Selecting affordance 802 may cause the system to perform RAG to generate a few-shot prompt using information associated with one or more example optimization problems, for instance, using one or more constraints associated with the one or more example optimization problems. The few-shot prompt generated upon selection of affordance 802 may be input into the constraints extraction LLM agent. GUI 800 shows a description of a plurality of constraints that were determined/generated using a constraint extraction LLM agent. GUI 800 may be configured such that users can revise the description of the constraints, delete constraints, and/or add new constraints.

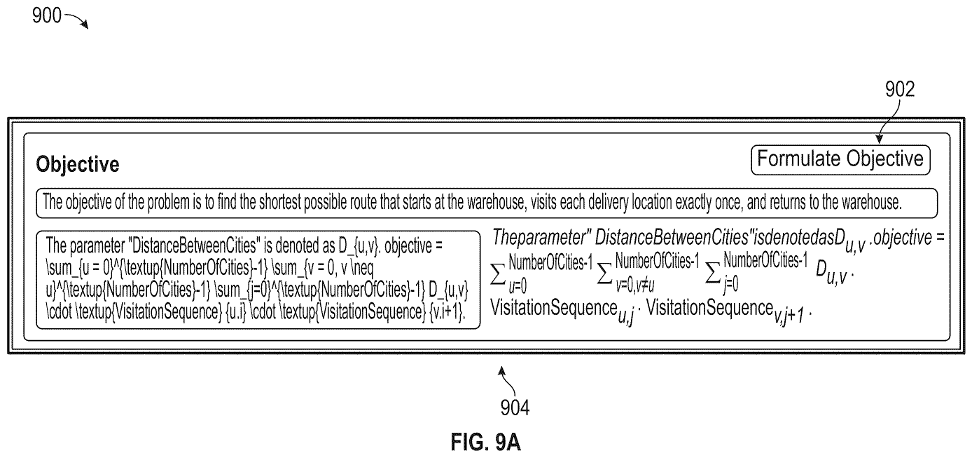

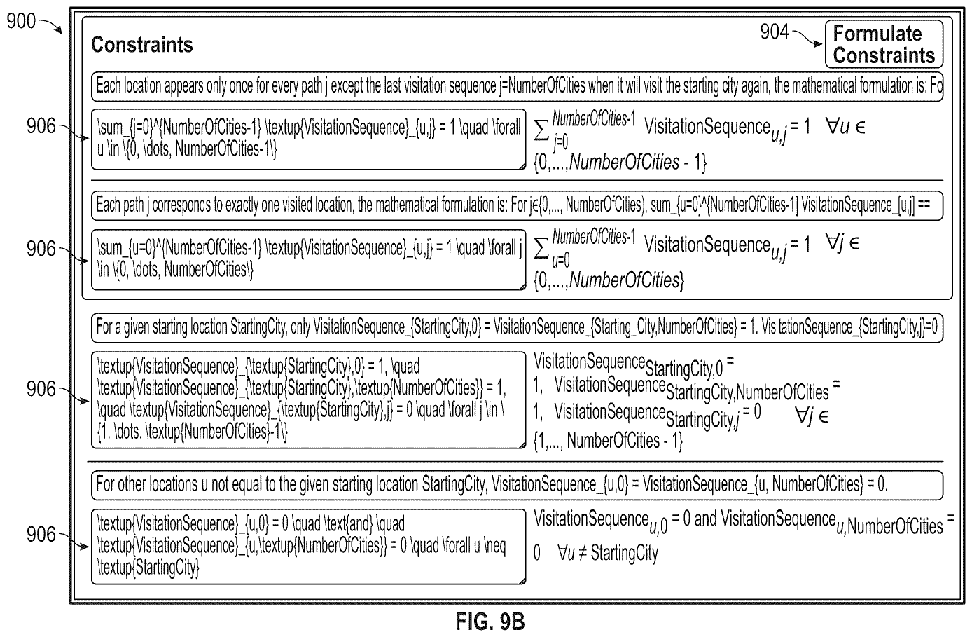

FIG. 9 illustrates aspects of an exemplary GUI 900 that may be used to implement and/or may include one or more of the aspects of the systems and methods described herein. GUI 900 may include an affordance 902 which when selected, may cause the system to generate one or more algorithmic representations 904 of the optimization objective using an objective formulator LLM agent. Selecting affordance 902 may cause the system to perform RAG to generate a few-shot prompt using information associated with one or more example optimization problems, for instance, using one or more algorithmic representations of optimization objectives associated with the one or more example optimization problems. The few-shot prompt generated upon selection of affordance 902 may be input into the objective formulator LLM agent. 9B illustrates additional aspects of GUI 900, including an affordance 904 that when selected causes the system to generate one or more algorithmic representations of the constraints 906 using a constraint formulator LLM agent. Selecting affordance 904 may cause the system to perform RAG to generate a few-shot prompt using information associated with one or more example optimization problems, for instance, using one or more algorithmic representations of optimization objectives associated with the one or more example optimization problems. The few-shot prompt generated upon selection of affordance 904 may be input into the constraint formulator LLM agent.

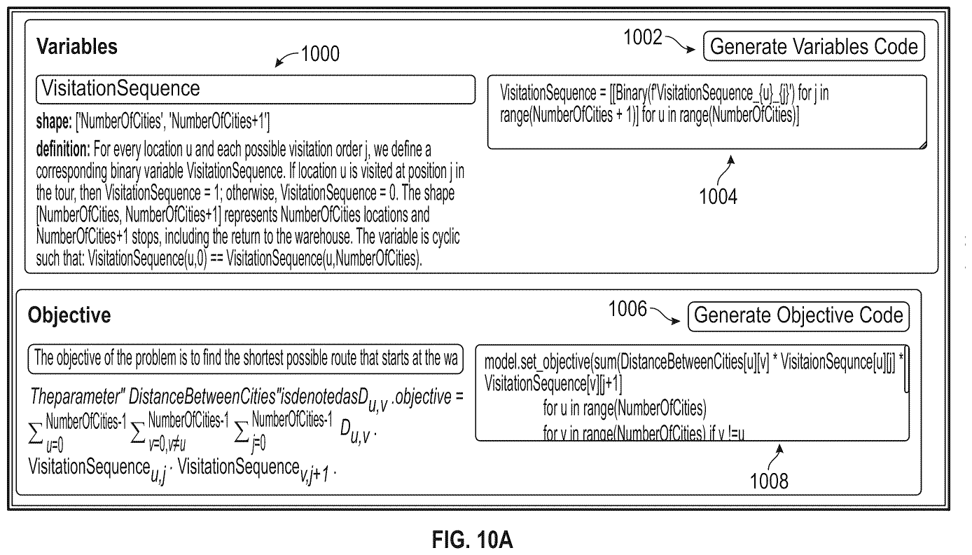

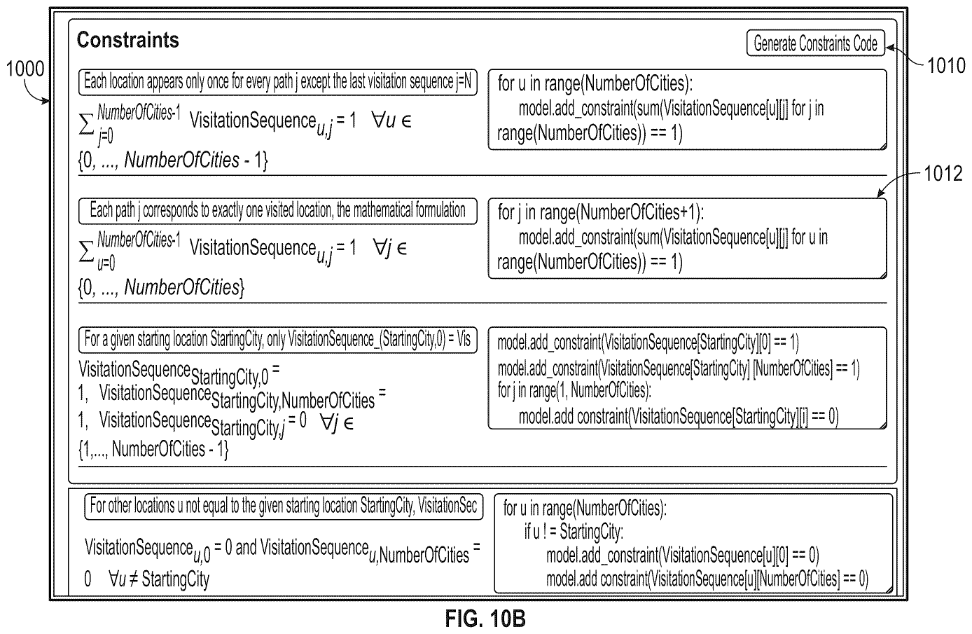

FIG. 10A illustrates a GUI 1000 that may be used to implement and/or may include one or more of the aspects of the systems and methods described herein. GUI 1000 may include one or more affordances 1002, which when selected, may cause the system to generate computer executable code 1004 to solve for the one or more decision variables using a variable code LLM agent. Selecting affordance 1002 may cause the system to perform RAG to generate a few-shot prompt using information associated with one or more example optimization problems, for instance, using computer executable code to solve for decision variables associated with the one or more example optimization problems. The few-shot prompt generated upon selection of affordance 1002 may be input into the variable code LLM agent. GUI 1000 may include an affordance 1006, which when selected, may cause the system to generate computer executable code 1008 specifying one or more characteristics of the objective using an objective code LLM agent. Selecting affordance 1006 may cause the system to perform RAG to generate a few-shot prompt using information associated with one or more example optimization problems, for instance, using computer executable code specifying one or more characteristics of an optimization objective associated with the one or more example optimization problems. The few-shot prompt generated upon selection of affordance 1002 may be input into the objective code LLM agent.

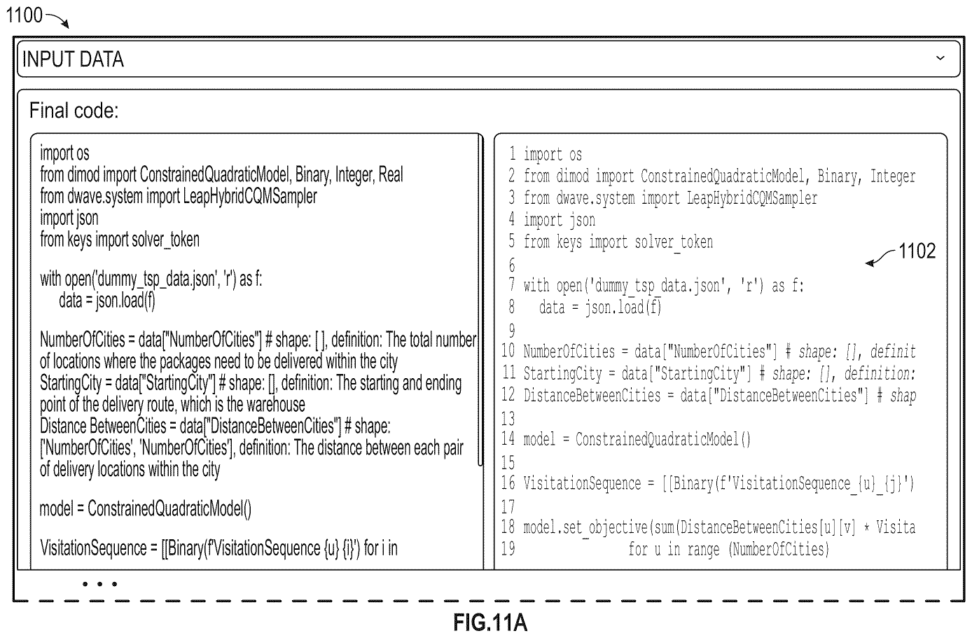

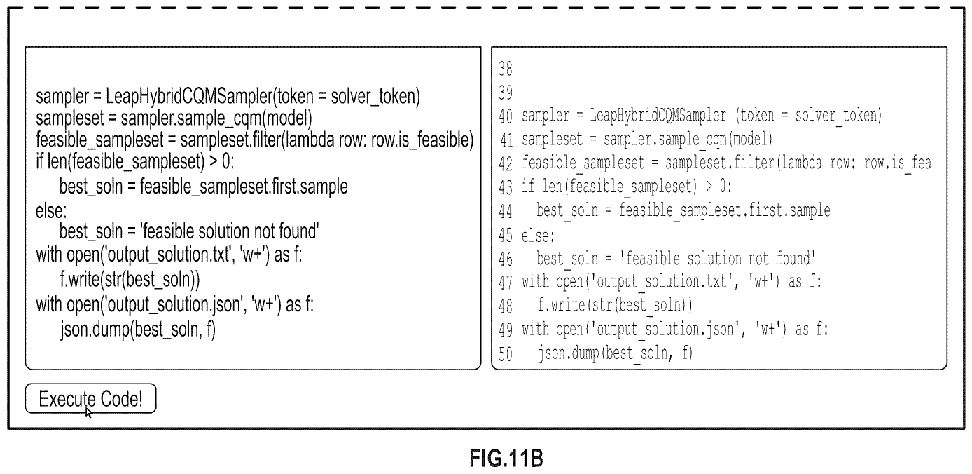

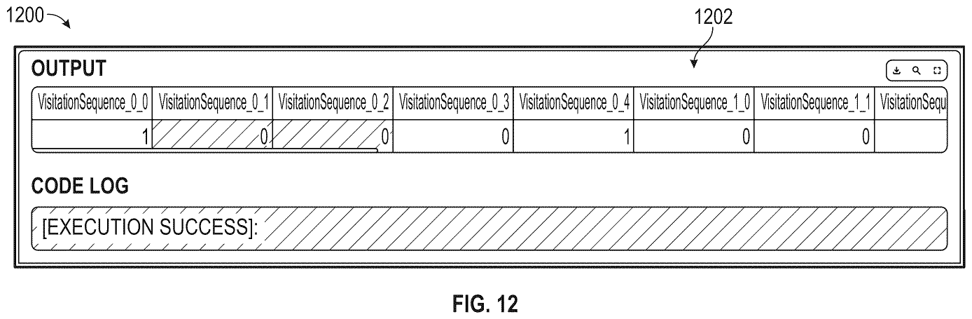

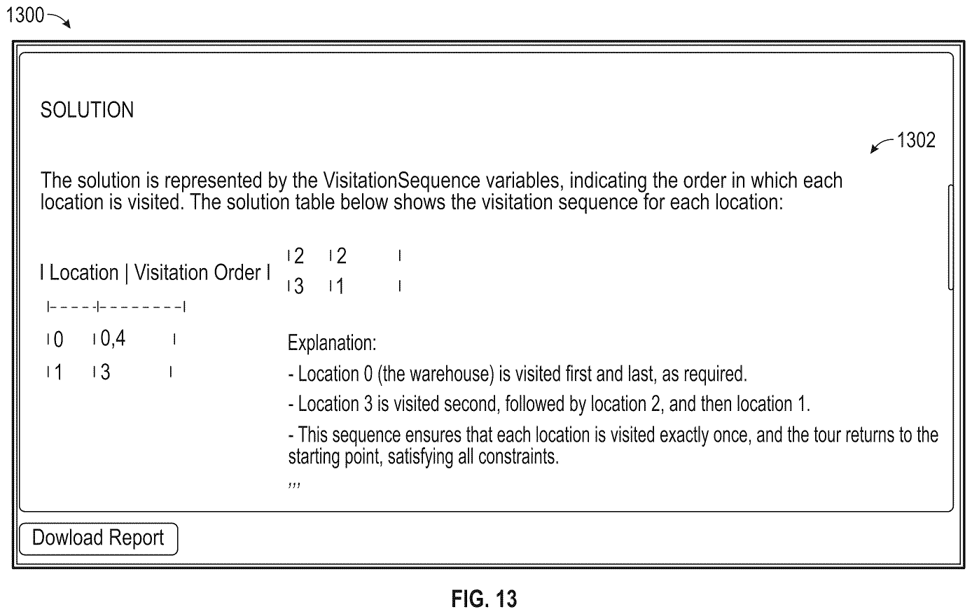

FIG. 10B illustrates additional aspects of GUI 1000, including an affordance 1010, which when selected, may cause the system to generate computer executable code 1012 defining the one or more constraints using a constraint code LLM agent. Selecting affordance 1010 may cause the system to perform RAG to generate a few-shot prompt using information associated with one or more example optimization problems, for instance, using computer executable code specifying one or more characteristics of constraints associated with the one or more example optimization problems. The few-shot prompt generated upon selection of affordance 1002 may be input into the constraint code LLM agent. FIGS. 11A and 11B illustrate aspects of GUI 1100, which shows exemplary finalized code 1102 generated using a plurality of LLM agents for solving the optimization problem. FIG. 12 shows an exemplary solution 1202 to an optimization problem that may be displayed in accordance with various examples described herein. FIG. 13 shows an exemplary report 1302 generated by a report generator LLM agent according to various examples described herein.

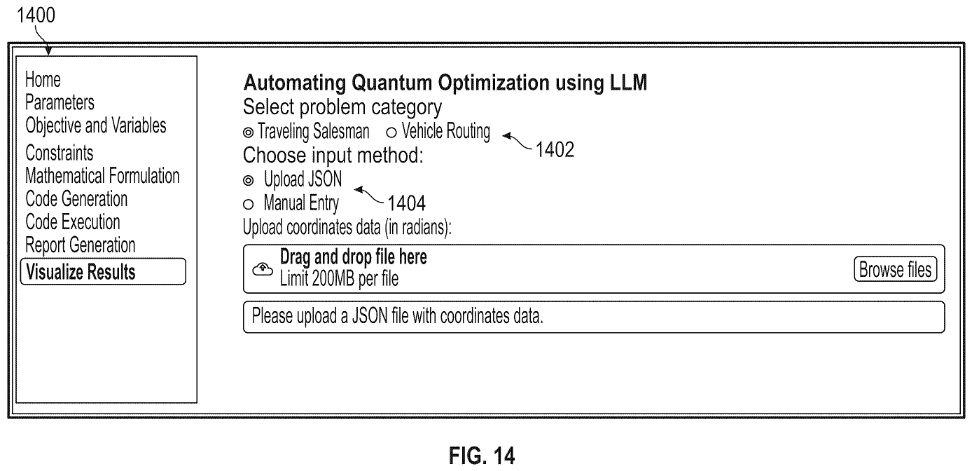

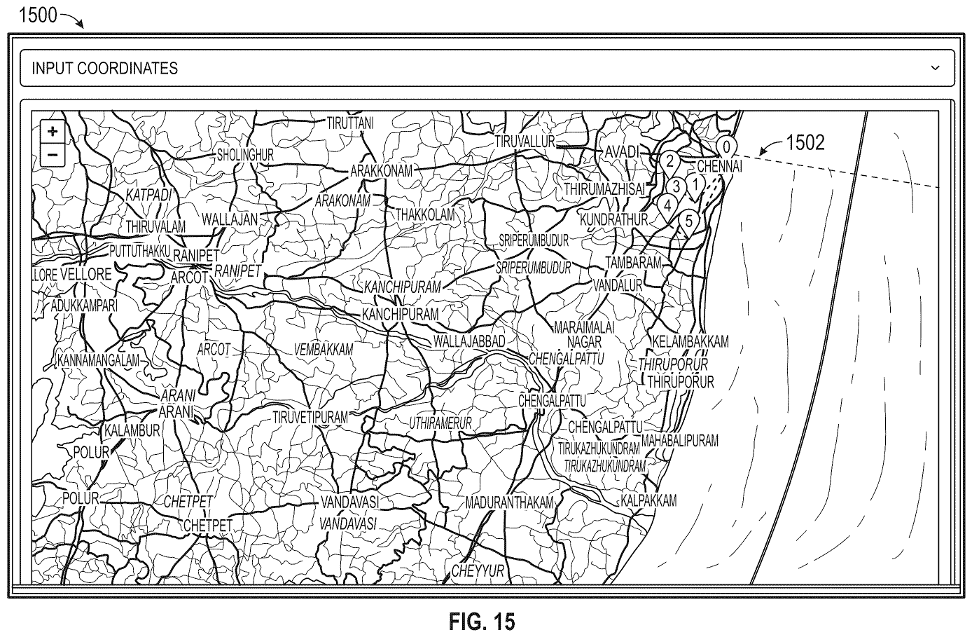

FIG. 14 illustrates aspects of an exemplary GUI 1400 for uploading data to visualize the solution to an optimization problem (e.g., by overlaying a route on a map interface). GUI 1400 may include one or more affordances 1402 for selecting a type of optimization problem (e.g., traveling salesman problem vs. vehicle routing problem). GUI 1400 may include one or more affordances 1404 for uploading and/or manually entering data associated with the optimization problem for visualization. FIG. 15 illustrates a GUI 1500 including a visualization 1502 of a solution to a traveling salesman problem overlaid on a map interface.

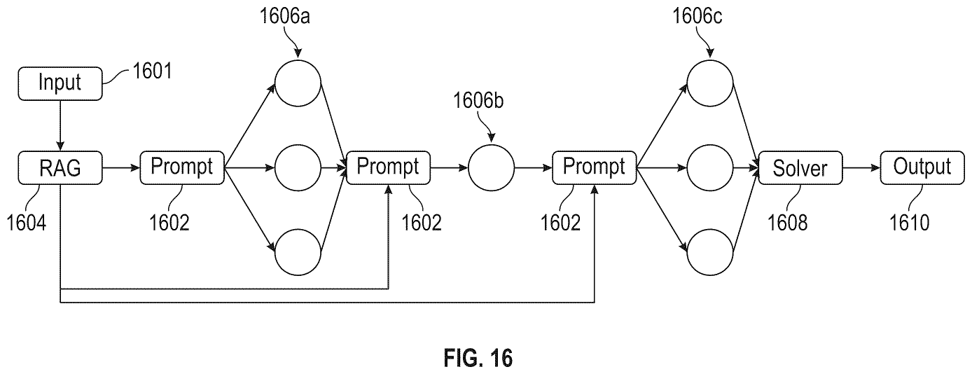

FIG. 16 illustrates an exemplary block diagram representing a computing system 1600 for solving optimization problems using a plurality of LLM agents. System 1600 may utilize one or more LLM agents in parallel with one another and may utilize one or more LLM agents in series with other LLM agents. For instance, a subset of LLM agents 1606a may operate in parallel with one another, a second one or more LLM agents 1606b may operate in series with the first subset of LLM agents 1606a and in series with a third subset of LLM agents 1606c. System 1600 may include any or all of the aspects of system 100. System 1600 may include a solver 1608, which may be used for or include aspects of solver 108 of system 100.

One or more prompts 1602 may be generated based on a user input 1601 via retrieval-augmented-generation (RAG) 1604. RAG may involve retrieving information associated with one or more example optimization problems from a database and dynamically generating prompts using the retrieved information, the user input 1601, and/or an output of one or more of the subsets of LLM agents 1606a-1606c (or one or more LLM agents included in a respective subset). Similar example optimization problems may be identified within the database by comparing an embedding generated using the input 1601 to one or more embeddings representing example optimization problems stored in the database (e.g., as described with reference to FIGS. 2-4.) Prompts for different subsets of LLM agents (or individual LLM agents included in each subset) may be generated using different subsets of information associated with the one or more optimization problems retrieved from the database (e.g., from a file stored at a location indicated by metadata of a respective embedding). The prompt 1602 for each LLM agent (or each subset of LLM agents) may be generated using a subset of information from the database relevant to the task assigned to that particular LLM agent or subset of LLM agents, e.g., as described throughout.

A prompt (or prompts) 1602 may be input into a first subset of LLM agents 1606a, which may process the prompt to extract various information and generate outputs including parameters, decision variable(s), an optimization objective, constraint(s), etc. as described throughout. The extracted information may be used, along with a second subset of information associated with one or more optimization problems from the database to generate an additional prompt or prompts 1602, which may be input into a second subset of one or more LLM agents 1606b. The second subset of one or more LLM agents 1606b may generate an output including an algorithmic representation of the prompt 1602 that specifies characteristics of the optimization problem in algorithmic terms.

The output of the first subset of LLM agents 1606a and/or the second subset of LLM agents 1606b may be used, along with a third subset of information associated with the one or more example optimization problems retrieved from the database, to generate a third prompt or prompts 1602. The third prompt or prompts may be input into a third subset of LLM agents 1606c. The third subset of LLM agents 1606c may process the third prompt (or prompts) 1602 to generate computer executable code configured to be input into a solver, such as a quantum solver and/or classical solver. The third subset of LLM agents 1606c may generate code for a quantum solver, code for a classical solver, or code for both a quantum and classical solver. The computer executable code may be input into a solver 1608 configured to generate a solution to the optimization problem. The solver 1608 may be a quantum solver or a classical solver. In some examples, quantum code is input into a first (quantum) solver and classical code is input into a second (classical) solver. The solver 1608 may generate an output 1610 that may be provided to a user and/or used to optimize various systems.

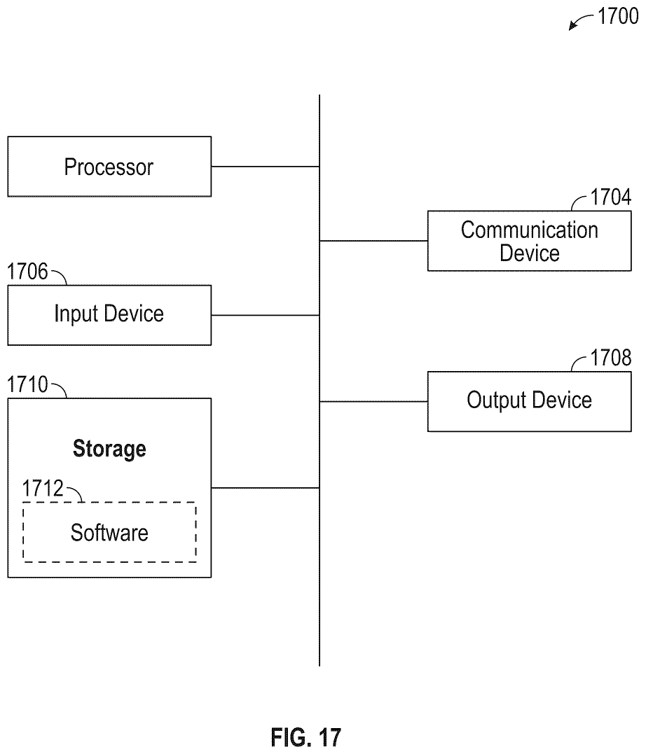

FIG. 17 depicts an exemplary computing device 1700, in accordance with one or more examples of the disclosure. Device 1700 can be a host computer connected to a network. Device 1700 can be a client computer or a server. As shown in FIG. 17, device 1700 can be any suitable type of microprocessor-based device, such as a personal computer, workstation, server, or handheld computing device (portable electronic device) such as a phone or tablet. The device can include, for example, one or more of processors 1702, input device 1706, output device 1708, storage 1710, and communication device 1704. Input device 1706 and output device 1708 can generally correspond to those described above and can either be connectable or integrated with the computer.

Input device 1706 can be any suitable device that provides input, such as a touch screen, keyboard or keypad, mouse, or voice-recognition device. Output device 1708 can be any suitable device that provides output, such as a touch screen, haptics device, or speaker.

Storage 1710 can be any suitable device that provides storage, such as an electrical, magnetic, or optical memory, including a RAM, cache, hard drive, or removable storage disk. Communication device 1704 can include any suitable device capable of transmitting and receiving signals over a network, such as a network interface chip or device. The components of the computer can be connected in any suitable manner, such as via a physical bus or wirelessly.

Software 1712, which can be stored in storage 1710 and executed by processor 1702, can include, for example, the programming that embodies the functionality of the present disclosure (e.g., as embodied in the devices as described above).

Software 1712 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1710, that can contain or store programming for use by or in connection with an instruction execution system, apparatus, or device.

Software 1712 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 1700 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 1700 can implement any operating system suitable for operating on the network. Software 1712 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

### EXAMPLES

1. A method for solving an optimization problem using a plurality of LLM agents, the method comprising:
receiving a user input comprising a natural language problem statement specifying one or more characteristics of the optimization problem;
generating one or more embeddings representing the user input;
querying a vector database using the one or more generated embeddings to
identify one or more example optimization problems;
retrieving information associated with one or more of the identified example optimization problems from a file location indicated by the vector database;
generating a plurality of few-shot prompts for an LLM agent pipeline comprising a plurality of LLM agents, wherein the plurality of few-shot prompts are generated using the user input and the information associated with the one or more example optimization problems, wherein generating the plurality of prompts for the plurality of LLM agents comprises:
   generating a first few-shot prompt for at least a first LLM agent based on the user input and a first subset of information from at least one of the one or more example optimization problems;
   generating a second few-shot prompt for at least a second LLM agent based on an output of at least the first LLM agent and a second subset of information from at least one of the one or more example optimization problems;
   generating a third few-shot prompt for at least a third LLM agent based on an output of at least the second LLM agent and a third subset of information from at least one of the one or more example optimization problems;
inputting a respective one of the plurality of generated prompts into each of the plurality of LLM agents; and
generating computer executable code specifying one or more characteristics of the optimization problem using the LLM agent pipeline comprising the first LLM agent, second LLM agent, and third LLM agent;
establishing a network connection with an optimization problem solver;
transmitting the computer executable code to the optimization problem solver over the established network connection;
receiving a solution to the optimization problem from the optimization problem solver via the established network connection; and
outputting the solution to the optimization problem.

2. The method of example 1, wherein the first LLM agent is configured to extract any one or more of parameters, an objective, decision variables, and constraints from the user input.

3. The method of any one of examples 1-2, wherein the second LLM agent is configured to formulate an algorithmic representation of the user input.

4. The method of any one of examples 1-3, wherein the third LLM agent is configured to generate the computer executable code representing the user input.

5. The method of any one of examples 1-4, wherein the one or more generated embeddings represent the natural language problem statement and the dataset.

6. The method of any one of examples 1-5, wherein the first subset of information comprises any one or more of parameters, an objective, decision variables, and constraints associated with the at least one example optimization problem.

7. The method of any one of examples 1-6, wherein the second subset of information comprises an algorithmic representation of the at least one example optimization problem.

8. The method of any one of examples 1-7, wherein the third subset of information comprises computer executable code for the at least one example optimization problem.

9. The method of any one of examples 1-8, wherein querying the vector database comprises identifying one or more embeddings included in the vector database similar to the one or more generated embeddings.

10. The method of any one of examples 1-9, comprising: generating the vector database, wherein generating the vector database comprises: ingesting a plurality of files, each file comprising information associated with at least one example optimization problem.

11. The method of example 10, wherein generating the vector database comprises generating a plurality of embeddings, wherein each of the plurality of embeddings represents one or more of the plurality of files.

12. The method of any one of examples 10-11, wherein generating the vector database comprises enhancing one or more of the plurality of files with synthetic case information, synthetic code, and synthetic programming modules to generate one or more enhanced files.

13. The method of example 12, wherein generating the vector database comprises: generating a plurality of embeddings, wherein a first embedding represents a first enhanced file of the one or more enhanced files and a second embedding represents a second enhanced file of the one or more enhanced files.

14. The method of any one of examples 12-13, wherein the synthetic case information, synthetic code, and synthetic programming modules used to enhance a file of the plurality of files are generated based on the information associated with the at least one example optimization problem included in the file.

15. The method of any one of examples 12-14, wherein the synthetic case information, synthetic code, and synthetic programming modules are generated using a large language model.

16. The method of any one of examples 1-15, comprising: configuring a computing system to maximize or minimize a value using the solution to the optimization problem, wherein the value comprises any one or more of: monetary cost, energy, material, time, distance, and computing resources.

17. The method of any one of examples 1-16, comprising automatically provisioning a computational resource based on the solution to the optimization problem.

18. The method of any one of examples 1-17, comprising automatically establishing a network connection based on the solution to the optimization problem.

19. The method of any one of examples 1-18, comprising sending a control signal to an electromechanical device based on the solution to the optimization problem.

20. The method of any one of examples 1-19, comprising displaying the solution to the optimization problem.

21. The method of any one of examples 1-20, wherein the user input comprises a dataset associated with the optimization problem.

22. A system for solving an optimization problem using a plurality of LLM agents, the system comprising: one or more processors, a memory, and one or more programs, wherein the one or more programs are stored in the memory and configured to be executed by the one or more processors, the one or more programs including instructions for:
receiving a user input comprising a natural language problem statement specifying one or more characteristics of the optimization problem;
generating one or more embeddings representing the user input;
querying a vector database using the one or more generated embeddings to identify one or more example optimization problems;
retrieving information associated with one or more of the identified example optimization problems from a file location indicated by the vector database;
generating a plurality of few-shot prompts for an LLM agent pipeline comprising a plurality of LLM agents, wherein the plurality of few-shot prompts are generated using the user input and the information associated with the one or more example optimization problems, wherein generating the plurality of prompts for the plurality of LLM agents comprises:
   generating a first few-shot prompt for at least a first LLM agent based on the user input and a first subset of information from at least one of the one or more example optimization problems;
   generating a second few-shot prompt for at least a second LLM agent based on an output of at least the first LLM agent and a second subset of information from at least one of the one or more example optimization problems;
   generating a third few-shot prompt for at least a third LLM agent based on an output of at least the second LLM agent and a third subset of information from at least one of the one or more example optimization problems;
inputting a respective one of the plurality of generated prompts into each of the plurality of LLM agents; and
generating computer executable code specifying one or more characteristics of the optimization problem using the LLM agent pipeline comprising the first LLM agent, second LLM agent, and third LLM agent;
establishing a network connection with an optimization problem solver;
transmitting the computer executable code to the optimization problem solver over the established network connection;
receiving a solution to the optimization problem from the optimization problem solver via the established network connection; and
outputting the solution to the optimization problem.

23. A non-transitory computer-readable storage medium storing one or more programs for for solving an optimization problem using a plurality of LLM agents, the one or more programs comprising instructions, which when executed by one or more processors of an electronic device, cause the electronic device to:
receive a user input comprising a natural language problem statement specifying one or more characteristics of the optimization problem;
generate one or more embeddings representing the user input;
query a vector database using the one or more generated embeddings to identify one or more example optimization problems;
retrieve information associated with one or more of the identified example optimization problems from a file location indicated by the vector database;
generate a plurality of few-shot prompts for an LLM agent pipeline comprising a plurality of LLM agents, wherein the plurality of few-shot prompts are generated using the user input and the information associated with the one or more example optimization problems, wherein generating the plurality of prompts for the plurality of LLM agents comprises:
   generating a first few-shot prompt for at least a first LLM agent based on the user input and a first subset of information from at least one of the one or more example optimization problems;
   generating a second few-shot prompt for at least a second LLM agent based on an output of at least the first LLM agent and a second subset of information from at least one of the one or more example optimization problems;
   generating a third few-shot prompt for at least a third LLM agent based on an output of at least the second LLM agent and a third subset of information from at least one of the one or more example optimization problems;
input a respective one of the plurality of generated prompts into each of the plurality of LLM agents; and
generate computer executable code specifying one or more characteristics of the optimization problem using the LLM agent pipeline comprising the first LLM agent, second LLM agent, and third LLM agent;
establish a network connection with an optimization problem solver;
transmit the computer executable code to the optimization problem solver over the established network connection;
receive a solution to the optimization problem from the optimization problem solver via the established network connection; and
output the solution to the optimization problem.

1. A method of configuring an optimization problem solver to generate a solution using a plurality of LLM agents, the method comprising:
receiving a user input comprising a natural language problem statement specifying one or more characteristics of the optimization problem;
generating one or more embeddings representing the user input;
querying a vector database using the one or more generated embeddings to identify one or more example optimization problems;
retrieving information associated with one or more of the identified example optimization problems from a file location indicated by the vector database;
generating a plurality of prompts for an LLM agent pipeline comprising a plurality of LLM agents, wherein the plurality of prompts are generated using the user input and the information associated with the one or more example optimization problems;
inputting a respective one of the plurality of generated prompts into each of the plurality of LLM agents; and
generating computer executable code specifying one or more characteristics of the optimization problem using the LLM agent pipeline;
establishing a network connection with an optimization problem solver;
transmitting the computer executable code to the optimization problem solver over the established network connection;
receiving a solution to the optimization problem from the optimization problem solver via the established network connection; and
outputting the solution to the optimization problem.

2. The method of claim 1, wherein generating the plurality of prompts for the plurality of LLM agents comprises:
generating a first prompt for at least a first LLM agent based on the user input and a first subset of information from at least one of the one or more example optimization problems;
generating a second prompt for at least a second LLM agent based on an output of at least the first LLM agent and a second subset of information from at least one of the one or more example optimization problems;
generating a third prompt for at least a third LLM agent based on an output of at least the second LLM agent and a third subset of information from at least one of the one or more example optimization problems.

3. The method of claim 2, wherein the first LLM agent is configured to extract any one or more of parameters, an objective, decision variables, and constraints from the user input.

4. The method of claim 2, wherein the second LLM agent is configured to formulate an algorithmic representation of the user input.

5. The method of claim 2, wherein the third LLM agent is configured to generate the computer executable code representing the user input.

6. The method of claim 1, wherein the one or more generated embeddings represent the natural language problem statement and the dataset.

7. The method of claim 1, wherein the first subset of information comprises any one or more of parameters, an objective, decision variables, and constraints associated with the at least one example optimization problem.

8. The method of claim 1, wherein the second subset of information comprises an algorithmic representation of the at least one example optimization problem.

9. The method of claim 1, wherein the third subset of information comprises computer executable code for the at least one example optimization problem.

10. The method of claim 1, wherein querying the vector database comprises identifying one or more embeddings included in the vector database similar to the one or more generated embeddings.

11. The method of claim 1, comprising: generating the vector database, wherein generating the vector database comprises: ingesting a plurality of files, each file comprising information associated with at least one example optimization problem.

12. The method of claim 10, wherein generating the vector database comprises generating a plurality of embeddings, wherein each of the plurality of embeddings represents one or more of the plurality of files.

13. The method of claim 10, wherein generating the vector database comprises enhancing one or more of the plurality of files with synthetic case information, synthetic code, and synthetic programming modules to generate one or more enhanced files.

14. The method of claim 12, wherein generating the vector database comprises:
generating a plurality of embeddings, wherein a first embedding represents a first enhanced file of the one or more enhanced files and a second embedding represents a second enhanced file of the one or more enhanced files.

15. The method of claim 12, wherein the synthetic case information, synthetic code, and synthetic programming modules used to enhance a file of the plurality of files are generated based on the information associated with the at least one example optimization problem included in the file.

16. The method of claim 12, wherein the synthetic case information, synthetic code, and synthetic programming modules are generated using a large language model.

17. The method of claim 1, comprising: configuring a computing system to maximize or minimize a value using the solution to the optimization problem, wherein the value comprises any one or more of: monetary cost, energy, material, time, distance, and computing resources.

18. The method of claim 1, comprising:
automatically provisioning a computational resource based on the solution to the optimization problem;
automatically establishing a network connection based on the solution to the optimization problem;
sending a control signal to an electromechanical device based on the solution to the optimization problem;
displaying the solution to the optimization problem; or
a combination thereof.

19. The method of claim 1, wherein the user input comprises a dataset associated with the optimization problem.

20. A system for configuring an optimization problem solver to generate a solution using a plurality of LLM agents, the system comprising: one or more processors, a memory, and one or more programs, wherein the one or more programs are stored in the memory and configured to be executed by the one or more processors, the one or more programs including instructions for:
receiving a user input comprising a natural language problem statement specifying one or more characteristics of the optimization problem;
generating one or more embeddings representing the user input;
querying a vector database using the one or more generated embeddings to identify one or more example optimization problems;
retrieving information associated with one or more of the identified example optimization problems from a file location indicated by the vector database;
generating a plurality of prompts for an LLM agent pipeline comprising a plurality of LLM agents, wherein the plurality of prompts are generated using the user input and the information associated with the one or more example optimization problems;
inputting a respective one of the plurality of generated prompts into each of the plurality of LLM agents; and
generating computer executable code specifying one or more characteristics of the optimization problem using the LLM agent pipeline;
establishing a network connection with an optimization problem solver;
transmitting the computer executable code to the optimization problem solver over the established network connection;
receiving a solution to the optimization problem from the optimization problem solver via the established network connection; and
outputting the solution to the optimization problem.

21. A non-transitory computer-readable storage medium storing one or more programs for configuring an optimization problem solver to generate a solution using a plurality of LLM agents, the one or more programs comprising instructions, which when executed by one or more processors of an electronic device, cause the electronic device to:
receive a user input comprising a natural language problem statement specifying one or more characteristics of the optimization problem;
generate one or more embeddings representing the user input;
query a vector database using the one or more generated embeddings to identify one or more example optimization problems;
retrieve information associated with one or more of the identified example optimization problems from a file location indicated by the vector database;
generate a plurality of prompts for an LLM agent pipeline comprising a plurality of LLM agents, wherein the plurality of prompts are generated using the user input and the information associated with the one or more example optimization problems;
input a respective one of the plurality of generated prompts into each of the plurality of LLM agents; and
generate computer executable code specifying one or more characteristics of the optimization problem using the LLM agent pipeline;
establish a network connection with an optimization problem solver;
transmit the computer executable code to the optimization problem solver over the established network connection;
receive a solution to the optimization problem from the optimization problem solver via the established network connection; and
output the solution to the optimization problem.
